(19) United States
(12) Patent Application Publication
(10) Pub. No.: US 2024/0377254 A1
(43) Pub. Date: Nov. 14, 2024

(54) ELECTRICALLY MODULATED LIGHT SOURCE

(71) Applicants: Tsinghua University, Beijing (CN); HON HAI PRECISION INDUSTRY CO., LTD., New Taipei (TW)

(72) Inventors: LI-WEN LAI, Beijing (CN); PENG LIU, Beijing (CN); DUAN-LIANG ZHOU, Beijing (CN); QUN-QING LI, Beijing (CN); SHOU-SHAN FAN, Beijing (CN)

(21) Appl. No.: 18/637,217

(22) Filed: Apr. 16, 2024

(30) Foreign Application Priority Data
May 9, 2023 (CN) 202310519664.8

(51) Int. Cl. G01J 3/10; G01N 21/3504

(52) U.S. Cl. CPC G01J 3/108; G01N 21/3504; G01N 2201/0691

(57) ABSTRACT

An electrically modulated light source comprises a carbon nanotube-graphene composite film structure, a first electrode and a second electrode. The carbon nanotube-graphene composite film structure comprises a carbon nanotube layer and a graphene layer stacked with each other. The first electrode and the second electrode electrically coupled with nanotube-graphene composite film structure. The first electrode and the second electrode are configured to apply a voltage to the carbon nanotube-graphene composite film structure.

### CROSS-REFERENCE TO RELATED APPLICATIONS

This application claims all benefits under 35 U.S.C. § 119 from the Chinese Patent Application No.202310519664.8, filed on May 9, 2023, in the China National Intellectual Property Administration, the disclosure of which is incorporated herein by reference.

### FIELD

The disclosure relates to an electrically modulated light source.

### BACKGROUND

As the global industrialization process gradually matures, industrial production emits a large amount of greenhouse gases and even polluting gases into the environment. These gases not only cause the surface temperature to rise, but also pose a threat to human health. Therefore, detecting the content of these gases in the environment, and taking improvement measures is an important task for environmental protection. General gas systems, especially atmospheric environments, require real-time quantitative detection. At the same time, the detection system is required to have stable performance and be able to respond quickly and detect tiny contents. Non-Dispersive Infrared (NDIR) spectrum detector fits this characteristic perfectly. It has a simple structure, flexible replacement of components, low cost, and high gas specificity.

Modulated light sources are widely used in NDIR spectrum detectors. NDIR spectrum detectors using modulated light sources are widely popular and used because of their small size, high stability, and high-test accuracy. Compared with non-optical detection methods, the NDIR spectrum detection method using modulated light source has higher sensitivity, selectivity and stability; it has a long service life and a relatively short reaction time, and can realize online real-time detection; and the performance will not be affected by the environment.

Traditional modulated light sources include mechanically modulated light sources, mid-infrared laser light sources, lead salt diode lasers and nonlinear light sources. However, mechanically modulated light sources require high mechanical precision and time resolution, slow modulation response, and easily affect the optical path; mid-infrared laser light sources lack the stability of continuous wavelengths; lead salt diode lasers have low output power and high cooling requirements; and the complexity and low power of nonlinear light sources. These traditional modulated light sources limit the application of NDIR spectrum detectors.

### BRIEF DESCRIPTION OF THE DRAWINGS

In order to illustrate the technical solutions of the embodiments of the present application more clearly, the accompanying drawings in the embodiments will be briefly introduced below. It should be understood that the following drawings only show some embodiments of the present application, and therefore should not be seen as limiting the scope. For one of ordinary skill in the art, other related drawings can also be obtained from these drawings without any creative work.

FIG. 1 is a schematic structural diagram of an electrically modulated light source provided by one embodiment of the present disclosure.

FIG. 2 is a scanning electron microscope photo of the carbon nanotube-graphene composite film structure provided by one embodiment of the present disclosure.

FIG. 3 is a scanning electron microscope photograph obtained after partially enlarging the carbon nanotube-graphene composite film structure in FIG. 2.

FIG. 4 shows comparation of pulse signals and radiation signals in two wavelength regions of 0.35-1.1 micron and 2.0-10.6 when the electrically modulated light source provided by the embodiment of the present invention is pulse modulated with a pulse duty cycle of 50% and a frequency of 10 Hz, wherein the abscissa is time and the ordinate is heating voltage and radiation signal.

FIG. 5 shows a time-varying curve of the radiation signal of the carbon nanotube-graphene composite film structure in the 0.35-1.1 μm wavelength region when the pulse duty cycle is 50% and the frequency is 20-500 Hz.

FIG. 6 shows a time-varying curve of the radiation signal of the carbon nanotube-graphene composite film structure in the 0.35-1.1 μm wavelength region when the pulse duty cycle is 50% and the frequency is in a range of 1 k-50 KHz.

FIG. 7 shows a time-varying curve of the radiation signal of the carbon nanotube-graphene composite film structure in the 2.0-10.6 μm wavelength region when the pulse duty cycle is 50% and the frequency is 20-500 Hz.

FIG. 8 shows a time-varying curve of the radiation signal of the carbon nanotube-graphene composite film structure in the 2.0-10.6 μm wavelength region when the pulse duty cycle is 50% and the frequency is 1k-15 kHz.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to be considered as limiting the scope of the embodiments described herein.

The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

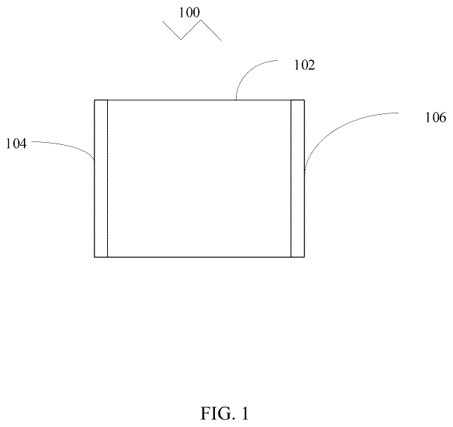

Referring to FIG. 1, one embodiment of the present disclosure provides an electrically modulated light source 100. The electrically modulated light source 100 comprises a carbon nanotube-graphene composite film structure 102, a first electrode 104 and a second electrode 106. A voltage is applied to both ends of the electrically modulated light source through the first electrode 104 and the second electrode 106. The electrically modulated light source 100 can instantly heat up and emit thermal radiation in a raise time less than 10 milliseconds after the voltage is applied. The electrically modulated light source 100 can instantly cool down to its original state in a falling time less than 10 milliseconds after the voltage is removed.

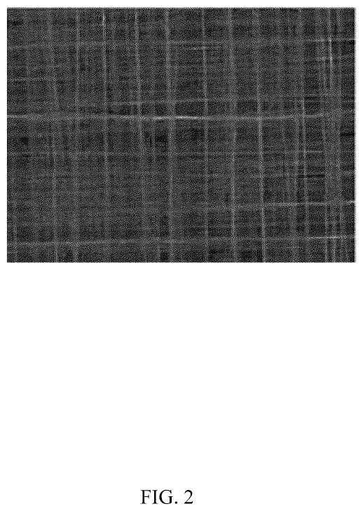

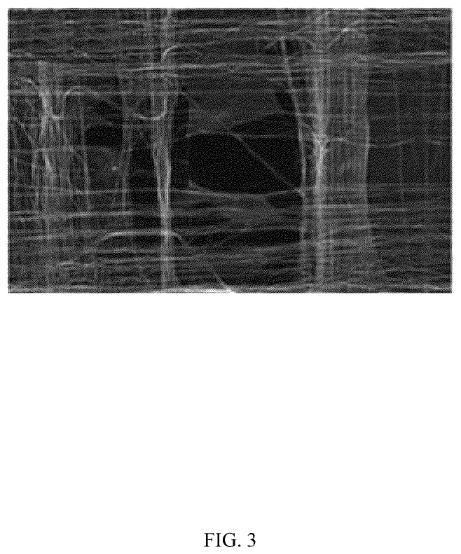

The carbon nanotube-graphene composite film structure comprises a carbon nanotube layer and a graphene layer stacked with each other. The carbon nanotube layer comprises a plurality of carbon nanotubes connected by van der Waals force. The carbon nanotube layer comprises a least one super-aligned carbon nanotube film. The carbon nanotube layer can be a structure comprising only carbon nanotubes. The carbon nanotube layer can comprise one layer of super-aligned carbon nanotube film, or can comprise multiple layers of super-aligned carbon nanotube films stacked on each other. The graphene layer can be a complete graphene film, or can be a film-like structure formed by overlapping multiple layers of graphene films. In the carbon nanotube-graphene composite film structure, the carbon nanotube layer is used as a carrier, and the graphene layer is laid on a surface of the carbon nanotube layer to form the carbon nanotube-graphene composite film structure. In this embodiment, the carbon nanotube-graphene composite film structure is formed by laying four layers of vertically crossed super-aligned carbon nanotube films on a copper foil with graphene growing large crystal domains and then passing through ammonium sulfate solution to etch the copper foil with the solution. Referring to FIG. 2, the macrostructure of the carbon nanotube-graphene composite film structure presents a very clear cross network, and the structure of the heated carbon nanotube-graphene composite film also presents a clear cross network. Referring to FIG. 3, there is an obvious cross-stacked form of carbon nanotube bundles, and there is a thin film at the bottom. At the same time, the thin film is not complete, but is composed of large crystal domain graphene fragments growing on the copper foil. This results in holes in the underlying film. Due to the existence of graphene, the holes in the carbon nanotube super-aligned film can be filled by the graphene film and the permeability of the carbon nanotube super-aligned film can be reduced. At the same time, due to the very dense grid on the surface of the carbon nanotube super-aligned film, its reflectivity is very low, with the reflectance close to 0. Therefore, laying the graphene film on the surface of the super-aligned carbon nanotube film can effectively increase the emissivity of the super-aligned carbon nanotube film.

When the carbon nanotube layer in the carbon nanotube-graphene composite film structure comprises multiple layers of super-aligned carbon nanotube films, the plurality of super-aligned carbon nanotube films is stacked. The intersection angle between the carbon nanotubes in two super-aligned carbon nanotube films can be any angle, preferably 90 degrees. The carbon nanotube layer thus formed is more stable and less likely to be damaged.

The super-aligned carbon nanotube film comprises a plurality of carbon nanotubes. The plurality of carbon nanotubes is preferably aligned along a same direction. The preferred alignment means that the overall extension direction of most carbon nanotubes in the super-aligned carbon nanotube film is basically in a same direction. Moreover, the overall extension direction of most of the carbon nanotubes is substantially parallel to a surface of the super-aligned carbon nanotube film. There are a small number of randomly arranged carbon nanotubes in the super-aligned carbon nanotube film, and these carbon nanotubes will not have a significant impact on the overall alignment of most carbon nanotubes in the super-aligned carbon nanotube film. Therefore, it cannot be ruled out that there may be partial contact between juxtaposed carbon nanotubes among the most carbon nanotubes extending in the same direction in the super-aligned carbon nanotube film.

The super-aligned carbon nanotube film can be prepared in a large area, and by changing its size, number of layers, and a size or frequency of the applied voltage, its radiation energy distribution can be changed and optical signals with different frequencies can be obtained. Therefore, the electrically modulated light source using the carbon nanotube-graphene composite film structure has a flexible adjustability. In addition, in a vacuum environment, after the carbon nanotube-graphene composite film structure is energized, when the temperature of the carbon nanotube-graphene composite film structure reaches a certain level, the carbon nanotube-graphene composite film structure begins to radiate obvious visible light, and the detection band covers 0.35-1.1 microns (ultraviolet-visible-near infrared, UV-VIS-NIR) and 0.2-10.6 microns (near-infrared-mid-infrared, NIR-MIR). The carbon nanotube-graphene composite film structure can reach a temperature of 1000K or even higher in vacuum.

In one embodiment, in a temperature ranged of 800° C. to 1200° C., in a visible light band, the carbon nanotube-graphene composite film structure can emit thermal radiation in a time ranged from 3 milliseconds to 4 milliseconds after a voltage is applied on the carbon nanotube-graphene composite film structure.

In another embodiment, in a temperature ranged of 800° C. to 1200° C., in an infrared light band, the carbon nanotube-graphene composite film structure can emit thermal radiation in a time ranged from 2 milliseconds to 3 milliseconds after a voltage is applied on the carbon nanotube-graphene composite film structure.

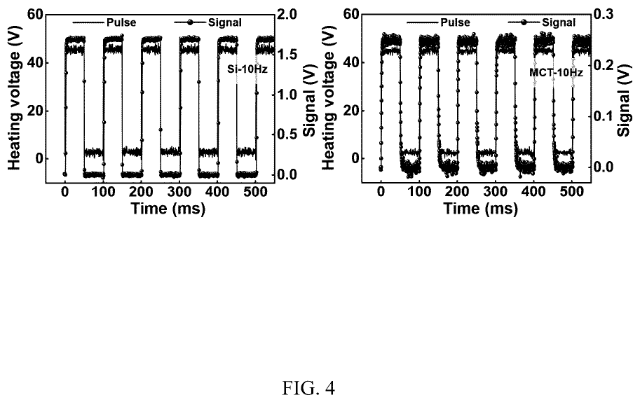

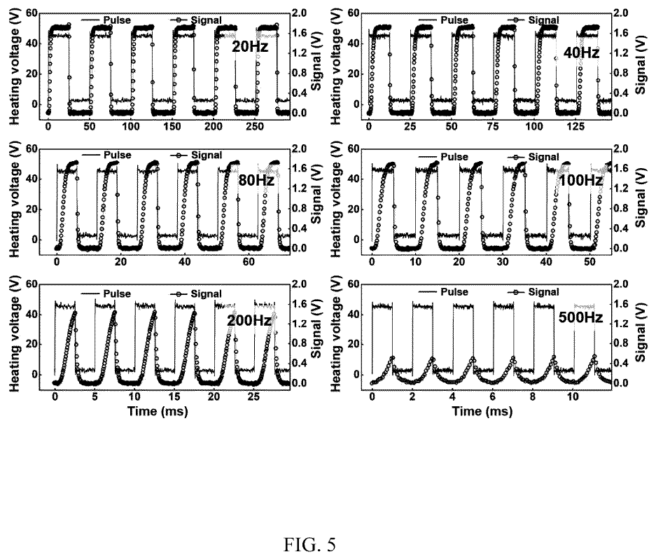

In one embodiment, the carbon nanotube-graphene composite film structure is modulated with a pulse with a duty cycle of 50%, and a mercury cadmium telluride detector and a silicon detector are used to detect the modulation signal when the peak temperature of the carbon nanotube-graphene composite film is 1066K, the modulation frequency is 10 Hz, and the mercury cadmium telluride detector and the silicon detector can detect radiation in the range of 2.0-10.6 μm and 0.35-1.1 μm respectively. For the radiation signals in the two bands of 2.0-10.6 μm and 0.35-1.1 μm, please see FIG. 4 for details. After calculation, in the 0.35-1.1 μm band, the rise time is 2.00±0.03 ms, and the fall time is in a range from 0.52-0.04 ms to 0.52±0.04 ms in the 2.0-10.6 μm band, the rise time is 2.01±0.06 ms, and the fall time is in a range from 3.12-0.37 ms to 3.12±0.37 ms. The radiation signal of the carbon nanotube-graphene composite film structure can respond quickly to the pulse signal. In the modulation experiment, the radiation signal under the action of pulse modulation with frequencies from 20 Hz to 50 kHz was studied. The detailed results are shown in FIGS. 5 to 8. When the pulse duty cycle is fixed at 50% and its peak voltage is also fixed, when the frequency is large, the detector signal will become very small. Especially the MCT detector is uncooled. When the frequency is very high, the radiation signal becomes very small, causing the noise in the detected signal to be obvious. Therefore, among the results in the 2.0-10.6 μm band, only the results with frequencies up to 15 kHz are shown.

FIG. 4 shows the response of the carbon nanotube-graphene composite film structure 102 to the pulse voltage obtained by using the Si detector and the mercury cadmium telluride (MCT) detector in the time of domain analysis. It can be seen from FIG. 4 that the signals collected by the Si detector in the UV-VIS-NIR optical band and the signals collected by the MCT detector in the NIR-MIR band can be synchronized with the square wave pulse signal. FIG. 4 illustrates that, after a voltage is applied to the carbon nanotube-graphene composite film structure 102, the temperature of the carbon nanotube-graphene composite film structure 102 instantly rises and radiates outward. The radiated energy can be successfully detected by the Si detector and Mercury cadmium telluride (MCT) detector detects, so the carbon nanotube-graphene composite film structure 102 can be applied as a modulated ultraviolet to visible and infrared light source.

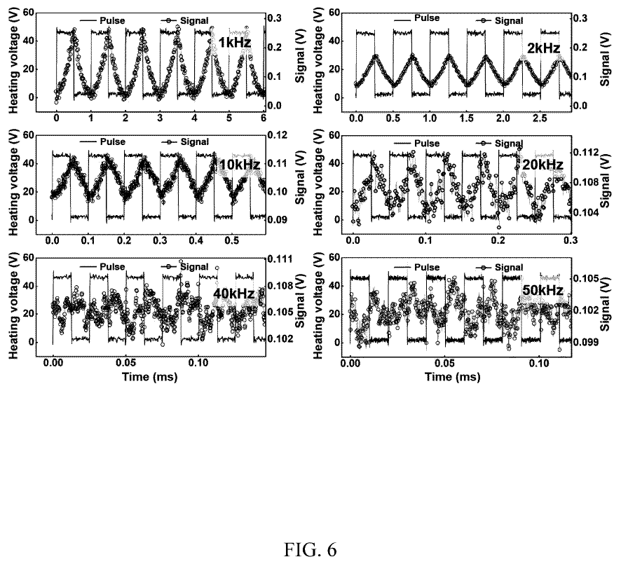

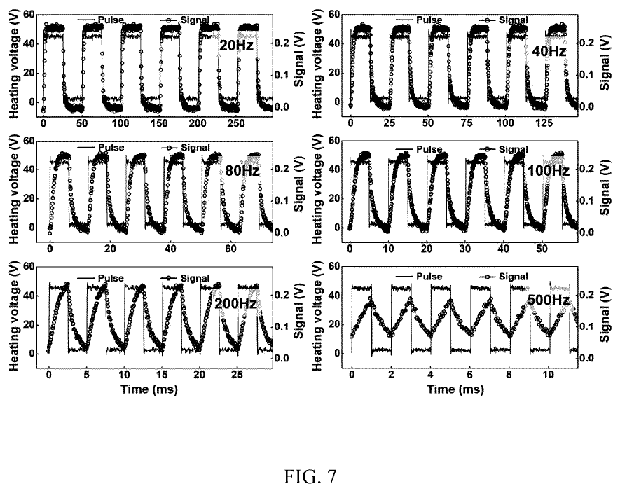

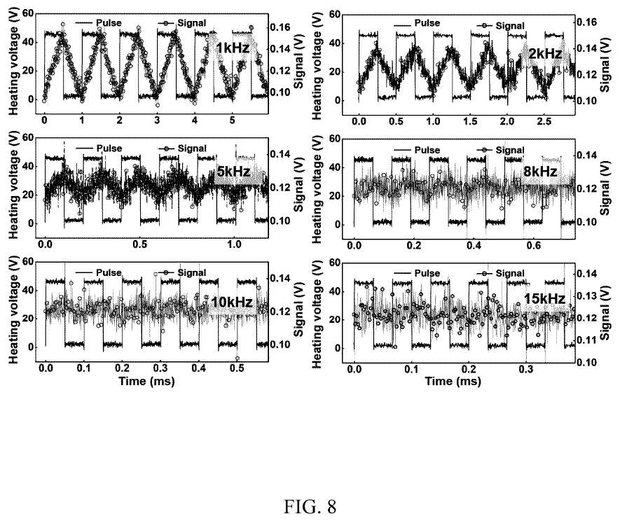

Referring to FIG. 5 and FIG. 6, which shows the radiation signal in the UV-VIS-NIR optical band obtained by the Si detector when the modulation frequency is 20-500 Hz. Please refer to FIG. 7 and FIG. 8, which show the radiation signal in the NIR-MIR optical band obtained by the MCT detector when the modulation frequency is 20-500 Hz. It can be seen from FIGS. 5-8 that the super-aligned carbon nanotube-graphene composite film structure can instantly heat up and emit thermal radiation after applying a voltage, and can radiate considerable detectable periodic radiation signals. The carbon nanotube-graphene composite film structure can radiate a light signal with time periodicity and synchronized with the modulation signal after being loaded with a pulse voltage. Since both super-aligned carbon nanotubes, carbon nanotube films and graphene have wandering light absorption properties in a very wide spectral range, they can also radiate light in a wide spectral range, thus the super-aligned carbon nanotubes-graphene composite film also has broad spectrum radiation capabilities.

The electrically modulated light source provided by the disclosure comprises a carbon nanotube-graphene composite film structure. The carbon nanotube-graphene composite film structure can radiate a wide spectrum and increase the loading of the carbon nanotube-graphene composite film structure. The radiant power can be increased by increasing the voltage or the layers of the super-aligned carbon nanotube film in the carbon nanotube-graphene composite film structure and the length of the super-aligned carbon nanotube film along the current direction. Therefore, the electrically modulated light source has advantages of flexible adjustability, easy to operate and does not affect the optical path. The electrically modulated light source can achieve a modulation frequency of greater than or equal to 150 kHz, and can rapidly heat up and cool down in about a few milliseconds or even hundreds of microseconds, and has a fast modulation response. Moreover, the electrically modulated light source is a carbon nanotube-graphene composite film structure. The preparation process is very simple and can be quickly prepared in a large area. The performance is stable and easy to preserve, and the cost is very low. Therefore, the electrically modulated light source of the present disclosure can achieve large-scale production size, it is expected to be used as a wide-spectrum light source. For example, it can be used as an electrically modulated light source in non-dispersive infrared gas monitoring. By using multiple narrow-band filters of different wavelengths, a variety of different gases can be tested. If filters with different wavelength bands are used, optical filters can be used to construct light sources that meet the needs of different wavelength bands. The carbon nanotube-graphene composite film structure can reach very high temperatures in vacuum, and the electrical modulation frequency of the electrically modulated light source can reach 150 kHz or even more than 150 kHz, which is the existing electrically modulated heat source.

The electrically modulated light source of the present disclosure has a wide range of applications. For example, it can be used as a high-frequency modulated light source to replace optical detection methods that require mechanical modulation such as choppers; it can also be used for gas detection in non-dispersive infrared spectrum detection methods; it can also be used as a light source for Fourier transform infrared spectrometers or other occasions to test the properties of samples, such as absorption spectrum, transmission and reflection, etc.; it can also be prepared into a light source array; or graphene can be composited with other films, such as ultra-thin metal films, dielectric films, etc.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

Depending on the embodiment, certain of the steps of methods described may be removed, others may be added, and the sequence of steps may be altered. The description and the claims drawn to a method may comprise some indication in reference to certain steps. However, the indication used is only to be viewed for identification purposes and not as a suggestion for ordering the steps.

What is claimed is:

1. An electrically modulated light source, comprising:
a carbon nanotube-graphene composite film structure comprising a carbon nanotube layer and a graphene layer stacked with each other; and
a first electrode and a second electrode electrically coupled with nanotube-graphene composite film structure and being configured to apply a voltage to the carbon nanotube-graphene composite film structure.

2. The electrically modulated light source of claim 1, wherein the carbon nanotube layer comprises a plurality of carbon nanotubes connected with each other by van der Waals force.

3. The electrically modulated light source of claim 1, wherein the carbon nanotube layer comprises at least one super-aligned carbon nanotube film, each super-aligned carbon nanotube film comprises a plurality of carbon nanotubes oriented along a same direction.

4. The electrically modulated light source of claim 3, wherein the carbon nanotube layer comprises multiple layers of super-aligned carbon nanotube films stacked with each other.

5. The electrically modulated light source of claim 4, wherein an intersection angle between adjacent super-aligned carbon nanotube films is 90 degrees.

6. The electrically modulated light source of claim 4, wherein the carbon nanotube layer comprises four layers of super-aligned carbon nanotube films.

7. The electrically modulated light source of claim 1, wherein in the carbon nanotube-graphene composite film structure, the carbon nanotube layer is configured to be a carrier, and the graphene layer is laid on a surface of the carbon nanotube layer.

8. The electrically modulated light source of claim 1, wherein the graphene layer is a complete layer of graphene film.

9. The electrically modulated light source of claim 1, wherein the graphene layer comprises multiple layers of overlapping graphene films.

10. The electrically modulated light source of claim 1, wherein in a temperature ranged of 800°° C. to 1200° C., in a visible light band, the carbon nanotube-graphene composite film structure is capable of emitting thermal radiation in a time ranged from 3 milliseconds to 4 milliseconds after a voltage is applied on the carbon nanotube-graphene composite film structure.

11. The electrically modulated light source of claim 10, wherein a colling down time of the carbon nanotube-graphene composite film structure is ranged from 600 microseconds to 1 millisecond after the voltage is removed.

12. The electrically modulated light source of claim 1, wherein in a temperature ranged of 800°° C. to 1200° C., in an infrared light band, the carbon nanotube-graphene composite film structure is capable of emitting thermal radiation in a time ranged from 2 milliseconds to 3 milliseconds after a voltage is applied on the carbon nanotube-graphene composite film structure.

13. The electrically modulated light source of claim 12, wherein a colling down time of the carbon nanotube-graphene composite film structure is about 5 milliseconds after the voltage is removed.

14. The electrically modulated light source of claim 1, wherein, in a vacuum environment, after the carbon nanotube-graphene composite film structure is energized, the carbon nanotube-graphene composite film structure is capable of radiating visible light.
